(19) United States
(12) Patent Application Publication
(10) Pub. No.: US 2020/0371844 A1
(43) Pub. Date: Nov. 26, 2020

(54) METHOD FOR CREATING VIRTUAL MACHINE BASED ON HYPER-CONVERGED INFRASTRUCTURE

(71) Applicant: QNAP SYSTEMS, INC., New Taipei City (TW)

(72) Inventor: MING CHUN HSIA, NEW TAIPEI CITY (TW)

(21) Appl. No.: 16/879,158

(22) Filed: May 20, 2020

(30) Foreign Application Priority Data
May 24, 2019 (TW) 108118095

(51) Int. Cl. G06F 9/50; G06F 9/455

(52) U.S. Cl. CPC G06F 9/5077; G06F 2009/4557; G06F 2009/45562; G06F 9/45558

(57) ABSTRACT

A method for creating a virtual machine based on the hyper-converged infrastructure is provided. The method is adapted to be used in the hyper-converged infrastructure in which a control device controls a plurality of data servers. The method selects one data server to create the virtual machine according to a distribution status of the virtual-machine data across the data servers after receiving a request of creating the virtual machine.

### FIELD OF THE INVENTION

The present disclosure relates to a method for creating a virtual machine, and particularly to a method for creating a virtual machine based on the hyper-converged infrastructure.

### BACKGROUND OF THE INVENTION

Hyper-converged infrastructure (HCI) is a system which consolidates machines to provide a virtual file server center. In the system, a plurality of machines having respective storage devices are integrated together. These machines are managed by a control center such as a hypervisor to provide data storage and access services for external devices. The market of the hyper-converged infrastructure is increasing because complex hardware scheduling is not needed and it simplifies the management of the system.

In addition to serving as a file server system, the respective machines can provide their computing power to perform other operations, for example, executing virtual machine (VM) software. According to the related technology, the selection of the machine for executing the virtual machine software is usually performed based on parameters of computing power or operation loading. To execute the virtual machine software, the selected machine further needs related specified data. However, perhaps there is no such specified data stored in a machine with high computing power. Therefore, it usually takes considerable time to acquire the necessary data for the selected machine to run the virtual machine in the hyper-converged infrastructure. This operation seriously reduces the performance of the virtual machine.

### SUMMARY OF THE INVENTION

An aspect of the present disclosure provides a method for creating a virtual machine based on a hyper-converged infrastructure. The hyper-converged infrastructure includes a control device for controlling data servers and stores virtual-machine data divided into parts. A primary copy of each part of the virtual-machine data is stored in a primary data server of the data servers and a backup copy of each part of the virtual-machine data is stored in at least one backup data server of the data servers. At first, the control device designates the parts related to the virtual-machine data to be used for creating a virtual machine after receiving a request of creating the virtual machine. Then, the control device locates the primary data server and the at least one backup data server storing the primary copy and the backup copy of the designated parts related to the virtual-machine data. Subsequently, the control device selects one of the located data servers to create the virtual machine according to a distribution status of the virtual-machine data across the located data servers.

In an embodiment, in the step of the control device selecting one located data server to create the virtual machine according to the distribution status of the virtual-machine data across the located data servers, the method calculates a count value of each located data server wherein the count value represents the number of serving the primary data server corresponding to all parts of the virtual-machine data. Then, the method ranks the count values in a descending order and selects one located data server according to the ranking of the count values

In an embodiment, in the step of the control device selecting one located data server to create the virtual machine according to the distribution status of the virtual-machine data across the located data servers, the method calculates a quantity value of each located data server wherein the quantity value represents an amount of all parts of the virtual-machine data stored in each located data servers. Then, the method ranks the quantity values in a descending order and selects one located data server according to the ranking of the quantity values.

In an embodiment, the quantity value is expressed as an overall file size, a number of files or the like.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a block diagram illustrating the hyper-converged infrastructure according to an embodiment of the present disclosure;

FIG. 2 is a flowchart illustrating a method for creating a virtual machine based on the hyper-converged infrastructure according to an embodiment of the present disclosure; and

FIG. 3 is a schematic diagram showing the data distribution across the data servers.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

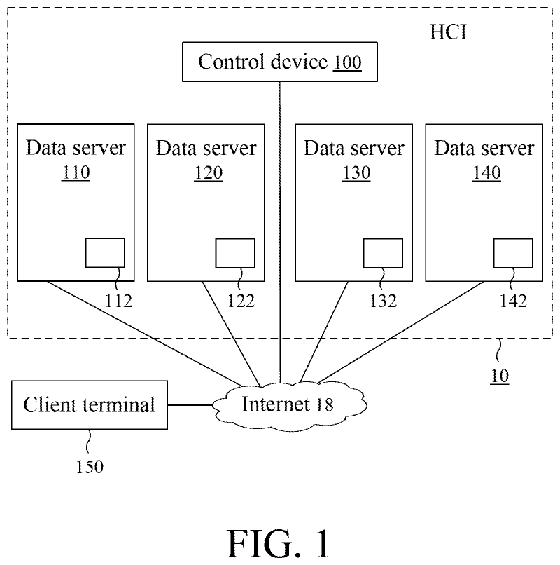

Please refer to FIG. 1, which is a block diagram illustrating the hyper-converged infrastructure according to an embodiment of the present disclosure. In the embodiment, the hyper-converged infrastructure 10 includes a control device 100 and four data servers 110, 120, 130 and 140, each of which includes a storage area for storing data. As shown in FIG. 1, the data server 110 includes a storage area 112, the data server 120 includes a storage area 122, the data server 130 includes a storage area 132, and the data server 140 includes a storage area 142. Each of these storage areas could be a part of a storage device, exactly one storage device or a combination of multiple storage devices. It is to be noted that the number of data servers is not limited to the embodiment.

In the hyper-converged infrastructure 10, the control device 100 controls the data transmission from/to the data servers 110, 120, 130 and 140. The control instruction or the data could be transmitted between the control device 100 and the data servers 110, 120, 130 and 140 through any network (e.g. internet 18) adapted to transmit electronic signals. Similarly, the signal could be transmitted between the client terminal 150 and the control device 100 or the data servers 110, 120, 130 and 140 through the internet 18.

When the client terminal 150 is going to write data into the hyper-converged infrastructure 10, these data are transmitted from the client terminal 150 to the control device 100 at first. The control device 100 determines the data storage location according to the loading of the data servers 110, 120, 130 and 140. The control device 100 could determine to write the data into a single data server or divide the data into parts to be stored in different data servers. The data server or data servers designated and involved in the determination step are called primary data server(s) corresponding to the data. Furthermore, the control device 100 duplicates the data and writes the backup copy into other data servers. The data servers for the backup copy are called backup data servers corresponding to the data. In the specification, the term “data” may represent specific combination of files.

For example, the control device 100 puts complete data D1 in the data server 110, and designates the data servers 130 and 140 to store a backup copy of the data D1. At this time, the data server 110 is the primary data server corresponding to the data D1, and the data servers 130 and 140 are the backup data servers corresponding to the data D1.

As another example, the control device 100 divides the data D1 into data D2 and D3, puts a primary copy of the data D2 in the data server 120, puts a primary copy of the data D3 in the data server 140, puts a backup copy of the data D2 in the data servers 110 and 140, and puts the backup copy of the data D3 in the data servers 120 and 130. At this time, according to the above definition, the primary data server corresponding to the data D2 is the data server 120, and the backup data servers corresponding to the data D2 are the data servers 110 and 140. Similarly, the primary data server corresponding to the data D3 is the data server 140, and the backup data servers corresponding to the data D3 are the data servers 120 and 130.

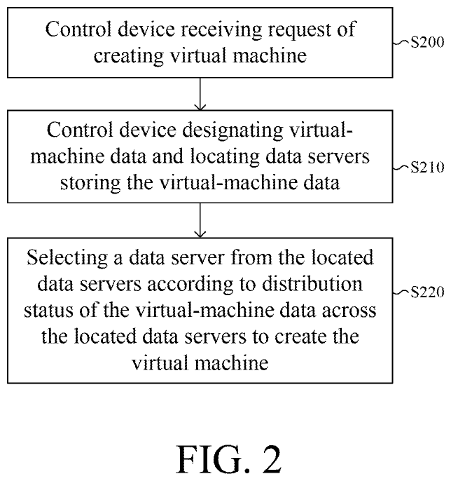

In addition to serving as a file server, each data server 110, 120, 130 or 140 can provide a varying number of virtual machine(s) on the basis of respective computing power. Please further refer to FIG. 2, which is a flowchart illustrating a method for creating a virtual machine based on the hyper-converged infrastructure according to an embodiment of the present disclosure. Once the client terminal 150 sends a request of creating a virtual machine to the hyper-converged infrastructure 10, the request is immediately transmitted to the control device 100 (step S200). After receiving the request, the control device 100 designates which data are required for creating the virtual machine, and locates the primary data server(s) and the backup data server(s) corresponding to the data (called virtual-machine data hereinafter) (step S210). Then, the control device 100 selects a data server, on which the virtual machine is to be created, among the located data servers according to the distribution status of the virtual-machine data across the located data servers (step S220).

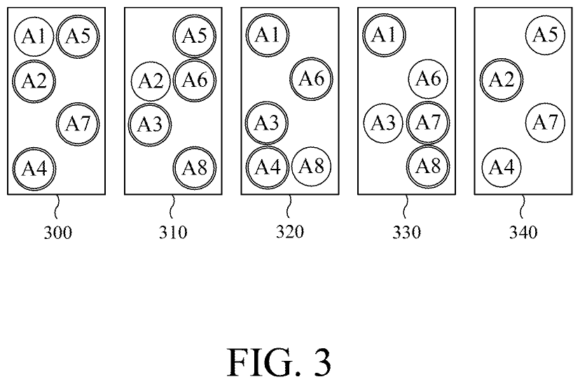

Please further refer to FIG. 3, which is a schematic diagram showing the data distribution across the data servers, to exemplify the actions performed in the steps S210 and S220. As shown in FIG. 3, the data involve eight parts A1, A2, A3, A4, A5, A6, A7 and A8 whose primary copies and backup copies are distributed in five data servers 300, 310, 320, 330 and 340. Each part A1˜A8 has a primary copy stored in one primary data server and two backup copies stored in two backup data servers, respectively. In this embodiment, regarding the data A1, the primary data server is the data server 300, and the backup data servers are the data servers 320 and 330; regarding the data A2, the primary data server is the data server 310, and the backup data servers are the data servers 300 and 340; regarding the data A3, the primary data server is the data server 330, and the backup data servers are the data servers 310 and 320; regarding the data A4, the primary data server is the data server 340, and the backup data servers are the data servers 300 and 320; regarding the data A5, the primary data server is the data server 340, and the backup data servers are the data servers 300 and 310; regarding the data A6, the primary data server is the data server 330, and the backup data servers are the data servers 310 and 320; regarding the data A7, the primary data server is the data server 340, and the backup data servers are the data servers 300 and 330; and regarding the data A8, the primary data server is the data server 320, and the backup data servers are the data servers 310 and 330.

To easily distinguish between the primary copy and the backup copy at a glance, the primary copy is marked with one circle, and the backup copy is marked with two circles in the diagram. For example, the symbol A1 in the data server 300 is marked with one circle because the data server 300 is the primary data server corresponding to the data A1, and each symbol A1 in the data servers 320 and 330 is marked with two circles because the data servers 320 and 330 are the backup data servers corresponding to the data A1. The data A1 are not stored in any other data servers, and thus no symbol A1 is shown in the data servers 310 and 340.

As described above, after the control device 100 receives the request of creating the virtual machine (step S200), the control device 100 designates the virtual-machine data required for creating the virtual machine, and then locates the primary data server(s) and the backup data server(s) which store the parts of the virtual-machine data (step S210). An example is that the control device 100 determines that the data A2, A3 and A6 are required for creating the virtual machine according to a preset rule or requirement in the request. Then, the control device 100 locates the primary data server (the data server 310) and the backup data servers (the data servers 300 and 340) corresponding to the data A2, locates the primary data server (the data server 330) and the backup data servers (the data servers 310 and 320) corresponding to the data A3, and locates the primary data server (the data server 330) and the backup data servers (the data servers 310 and 320) corresponding to the data A6.

After locating the data servers related to the virtual-machine data, the control device 100 selects one data server among the located data servers to create the virtual machine according to the distribution status of the virtual-machine data across the located data servers.

In an embodiment, the control device 100 selects one data server to create the virtual machine when the data server serves as the primary data server corresponding to the virtual-machine data the most times. Concretely, the control device 100 sets a count value for each located data server. For every part of the virtual-machine data, every time the current data server serves as the primary data server, the count value of the current data server is increased by 1. In other words, the count value is equal to the number of the primary copy related to the virtual-machine data stored in the data server. Finally, the data server corresponding to the greatest count value is selected to create the virtual machine. Now please refer to the case that the data A2, A3 and A6 are required to create the virtual machine. The data server 310 is the primary data server corresponding to the data A2, and the count value of the data server 310 is 1; and the data server 330 is the primary data server corresponding to the data A3 and A6, and the count value of the data server 330 is 2. Therefore, it is planned to create the virtual machine on the data server 330 corresponding to the greatest count value. If the data server 330 can not be used to create the virtual machine for some reasons, the virtual machine will be created on the data server 310 corresponding to the second greatest count value according to the ranking of the count values.

It is to be noted that although other data servers serve as primary data servers corresponding to the data A1, A4, A5, A7 and A8, these data are not parts of the virtual-machine data for this virtual machine to be created. Therefore, these data servers 300, 320 and 340 are not treated as candidate data servers.

In another embodiment, the control device 100 selects the data server to create the virtual machine according to the amount of the virtual-machine data stored in each of the located data servers. Referring to the case that the data A2, A3 and A6 are required to create the virtual machine, each data server 300˜340 has a primary copy or a backup copy of the data A2, A3 or A6. Hence, all of the data servers 300˜340 are related to the virtual-machine data and are treated as the candidate data servers.

As shown in FIG. 3, the data server 300 stores one part of the virtual-machine data (A2), the data server 310 stores three parts of the virtual-machine data (A2, A3 and A6), the data server 320 stores two parts of the virtual-machine data (A3 and A6), the data server 330 stores two parts of the virtual-machine data (A3 and A6), and the data server 340 stores one part of the virtual-machine data (A2). Therefore, the control device 100 selects the data server 310 which stores the most parts of the virtual-machine data to create the virtual machine. If the virtual machine can not be created on the data server 310 for some reasons, the control device 100 selects the data server 320 or 330 which stores the second most parts of the virtual-machine data to create the virtual machine. The final selection between the data servers 320 and 330 for creating the virtual machine could be made by any proper mechanism without departing from the present application.

In a further embodiment, the control device 100 may calculate the number of files related to the data A2, A3 and A6 or the overall file size related to the data A2, A3 and A6 in each data server as the basis to select the data server to create the virtual machine. It is to be noted that the amount of the virtual-machine data described in the present disclosure may represent the overall size of the related files, the number of the related files, the number of the related parts or any other measurement suitable for comparison, collectively called a quantity value of the data server.

The above embodiments could be implemented solely or in combination without departing from the present application. The details about the modifications are not particularly given herein.

In conclusion, the method for creating a virtual machine based on the hyper-converged infrastructure considers the distribution of the virtual-machine data across the data servers and selects the preferred data server to create the virtual machine according to the distribution status. Hence, less access time is required to create and run the virtual machine, which will raise the performance and work efficiency of the created virtual machine.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for creating a virtual machine based on a hyper-converged infrastructure including a control device for controlling a plurality of data servers and storing virtual-machine data divided into a plurality of parts, a primary copy of each part of the virtual-machine data being stored in a primary data server of the data servers and a backup copy of each part of the virtual-machine data being stored in at least one backup data server of the data servers, the method comprising steps of:
the control device designating the parts related to the virtual-machine data to be used for creating a virtual machine after receiving a request of creating the virtual machine;
the control device locating the primary data server and the at least one backup data server storing the primary copy and the backup copy of the designated parts related to the virtual-machine data; and
the control device selecting one of the located data servers to create the virtual machine according to a distribution status of the virtual-machine data across the located data servers.

2. The method according to claim 1, wherein the step of the control device selecting the one located data server to create the virtual machine according to the distribution status of the virtual-machine data across the located data servers further comprises steps of:
calculating a count value of each of the located data servers wherein the count value represents the number of serving the primary data server corresponding to all parts of the virtual-machine data; and
ranking the count values in a descending order and selecting the one located data server according to the ranking of the count values.

3. The method according to claim 1, wherein the step of the control device selecting the one located data server to create the virtual machine according to the distribution status of the virtual-machine data across the located data servers further comprises steps of:
calculating a quantity value of each of the located data servers wherein the quantity value represents an amount of all parts of the virtual-machine data stored in each of the located data servers; and
ranking the quantity values in a descending order and selecting the one located data server according to the ranking of the quantity values.

4. The method according to claim 3, wherein the quantity value is expressed as an overall file size.

5. The method according to claim 3, wherein the quantity is expressed as a number of files.
